(19) United States
(12) Patent Application Publication
(10) Pub. No.: US 2026/0127296 A1
(43) Pub. Date: May 7, 2026

(54) Server Inaccessible End-to-End Encrypted Data Protection

(71) Applicant: Joshua Joseph Boutwell, Kathleen, GA (US)

(72) Inventor: Joshua Joseph Boutwell, Kathleen, GA (US)

(21) Appl. No.: 18/937,021

(22) Filed: Nov. 5, 2024

(51) Int. Cl. G06F 21/60; G06F 21/64

(52) U.S. Cl. CPC G06F 21/602; G06F 21/606; G06F 21/64

(57) ABSTRACT

System and method for a data environment using linked chains of data packages and logical packages to allow for identification of server data from a local machine without allowing access to unencrypted data by the server. The local machine may identify all data packages and all logical packages in the data environment without downloading all data packages and logical packages providing for faster remote data use with improved security. Data packages and logical packages may be organized by their unique checksums. Header information contained within the data packages and logical packages allows a local machine to identify all data packages in the data environment while only downloading and decrypting a minimal number of data packages or logical packages and data.

### FIELD OF THE INVENTION

The present invention relates generally to the field of data environments. More specifically, the invention is in the subfield of data environments in end-to-end encrypted environments with data auditing processes.

### BACKGROUND OF THE INVENTION

Cloud-based data storage services provide a convenient and effective method for storing large amounts of data that may be accessed by an end user from a variety of locations or local machines. However, cloud-based data storage services are owned and operated by other persons or entities who may not be the owners of sensitive data stored on the cloud. These other persons or entities may have access to the operating system of the hardware storing the data, allowing access to any software applications running on the cloud based-storage. Furthermore, data is generally available to be compromised, altered, or exfiltrated by unauthorized third parties when on cloud storage and available for use by end users. Current methods of protecting data on cloud-based storage systems are to encrypt the data. However, a consequence of this encryption is that a user on a local machine cannot manipulate the data required for a particular user session without decryption and must download the entirety of the cloud-based storage. Alternatively, the server may be allowed to decrypt the data, but this necessarily increases the risk to data security. This places extra demands on hardware and data bandwidth. Furthermore, because of the weaknesses in cloud-based storage security, a user is often reliant on the cloud-based storage service provider to ensure that data is properly protected. As such, there is need in the art for a secure, remote database system that allows for enhanced security while reducing computational and hardware load on both the servers and local machines.

### SUMMARY OF THE INVENTION

An aspect of an embodiment of the present invention provides for an end-to-end encrypted data protection system using linked chains of data packages and logical packages that allows for local use of remotely stored data without the requirement to download all of the data in the data environment for a user session. The secure chain data environment utilizes a server which is blind to the data held within the data pool and never allows access to any unencrypted data to the server machine.

The secure chain data environment may comprise a data pool that is divided into logical groupings of data. These logical groupings of data are further subdivided into data packages which contain the encrypted data of the data pool and a header that provides bibliographic information regarding the data package and its relation to other packages in the secure chain data environment. Each logical grouping of data packages is tracked by a series of logical packages, which may also include a header and encrypted data that tracks the data packages associated with that logical group. The header of each data package and each logical package includes information on the preceding version of the data package or logical package to allow for the arrangement of data packages and logical packages into data chains and logical chains, which are linked lists of the version history of each series of data packages and logical packages. Data packages and logical packages are organized and identified by their unique checksums, which may be calculated from their encrypted state. This unique checksum identifier allows the server holding the data of the secure chain environment to maintain all data packages and logical packages with a simple list of checksums of all packages in the data pool without the ability to identify any data package or logical package and without access to the encrypted data contained therein. The listing of data packages and logical packages by checksum and with included header information allows a local machine to identify all data packages and logical packages without the need to download all data from the server.

### DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 provides a block diagram of an exemplary embodiment of a secure chain data environment system.

FIG. 2 provides a block diagram of the data structure of an exemplary embodiment of a secure chain data environment.

FIG. 3 provides a block diagram of the nested data structure of an exemplary embodiment of a secure chain data environment.

FIG. 4 provides a flowchart of an exemplary embodiment of a method for setting up or establishing a secure chain data environment.

FIG. 5 provides a schematic depiction of an exemplary embodiment of the data structure of a data package in a secure chain data environment.

FIG. 6 provides a schematic depiction of an exemplary embodiment of the data structure of a logical package in a secure chain data environment.

FIG. 7A provides a flowchart of an exemplary embodiment of a method for identifying data packages and logical packages in a secure chain data environment.

FIG. 7B provides a flowchart of an exemplary embodiment of a method for testing and rectifying data coherence in a secure chain data environment.

FIG. 8 provides a flowchart of an exemplary embodiment of a method for updating data chains and logical chains in a secure chain data environment.

### DETAILED DESCRIPTION OF EXEMPLARY EMBODIMENTS OF THE

### INVENTION

It should be appreciated that in the following description, the secure chain data environment may be referred to as a data environment, an end-to-end encrypted data protection system. The secure chain data environment may also be described with reference to a database. However, the secure chain data environment may be applied to any application or software wherein server-stored data is to be manipulated or otherwise used by local machines and is in no way limited only to use in a database application.

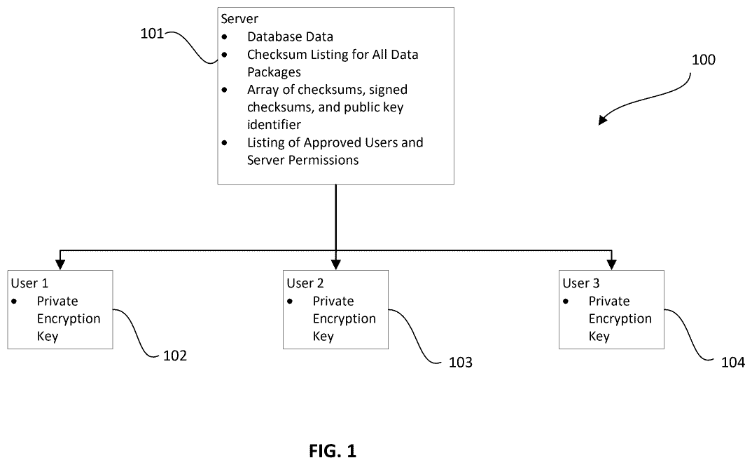

FIG. 1 provides a block diagram of an exemplary embodiment of the structure of a secure chain data environment 100. The secure chain data environment 100 may comprise a server 101 in electronic communication with a first user 102, a second user 103, and a third user 104. The server 101 may be a repository for all the database data, a listing of the checksums of all generic data packages contained on the server, and a listing of all approved users, server permissions, and authentication methods. The server 101 may also include or otherwise comprise an array containing a matched listing of all package checksums, an encrypted version of each package checksum, and the public key associated with that encrypted version of each package checksum. However, in certain embodiments, the server 101 may not have any information or the ability to decrypt or otherwise work with or manipulate the data contained within the generic data packages on the server 101. It should be appreciated that the server 101 may comprise one or more machines located in one or more locations. For example, in certain embodiments, the server 101 may comprise a group server which defines group global unique identifiers (GUIDs), a user server that defines user accounts and manages public signing certificates, and a data server which holds the encrypted data. However, any arrangement of machines and locations may be contemplated for use with the secure chain data environment 100 and providing necessary functions to the end user.

As shown, each of the users 102, 103, 104 may have a private encryption key which corresponds to one or more public encryption keys held on the server 101 in the array of checksums, encrypted checksums, and public keys. This private encryption key may be used to allow users 102, 103, 104 to sign the checksums of data that has been uploaded or manipulated within the secure data environment 100. For example, the first user 102 may upload a package to the server 101. In doing so, the first user 102 may sign the uploaded package by using his or her private key to encrypt the checksum of the uploaded package and associate this encrypted checksum with the uploaded package.

The server 101 may then store the checksum of the uploaded package, the encrypted version of the checksum for the uploaded package, and the public key for decrypting the encrypted checksum. Another user, such as the second user 103, may then verify the provenance of the data on the server 101 by decrypting the encrypted checksum with the provided public key stored on the server 101. If, after decrypting with the public key, the encrypted checksum matches the calculated checksum of the uploaded package, the second user 103 can be assured that the uploaded package was in fact uploaded by the person with access to the private key associated with the public key, in this case the first user 102. In this way, any user 102, 103, 104, or anyone with access to the list of owners or users of the one or more public keys stored on the server 101, may verify the provenance of the user 102, 103, 104 who uploaded any particular package in the secure chain data environment 100.

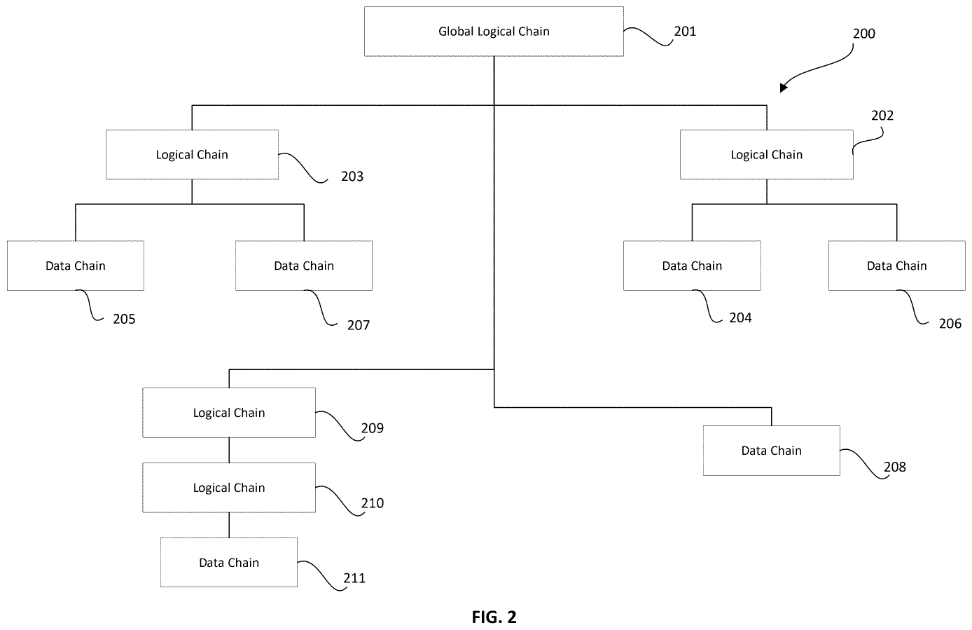

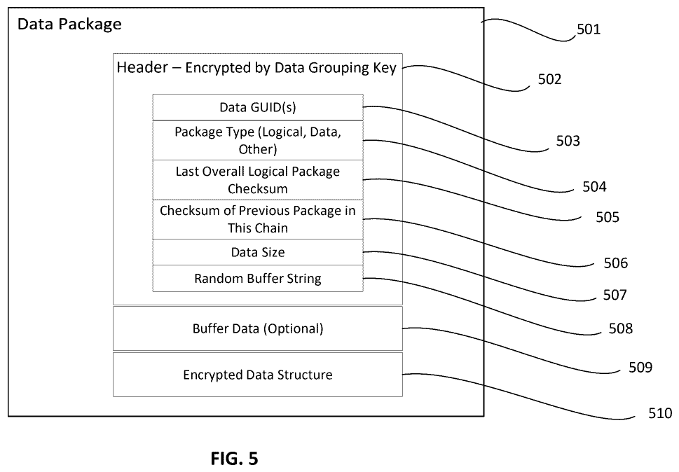

FIG. 2 provides a block diagram of an exemplary data structure 200 for use in a secure chain data environment. The data structure 200 may comprise one or more data chains 204, 205, 206, 207, 208, 211 which contain the encrypted data of the data environment. The data chains 204, 205, 206, 207, 208, 211 also contain other fields of data for organizing the data structure 200 as described below with reference to FIG. 5.

Each data chain 204, 205, 206, 207, 208, 211 represents a linked list of data packages.

Each data package represents one data chunk or partition of data in the data environment structure 200. Subsequently, each data chain 204, 205, 206, 207, 208, 211 represents a linked list of versions of each data package or partition. These data chains 204, 205, 206, 207, 208, 211 may be related to one another through the logical partitioning of the data environment data such that certain data chains 204, 205, 206, 207, 208, 211 may be grouped together based on logical divisions or partitions.

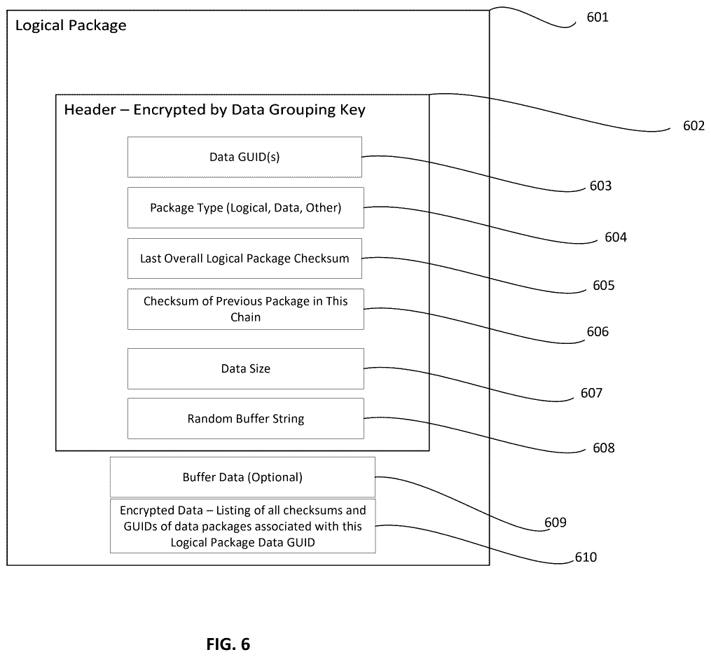

The data structure 200 may also include one or more logical chains 202, 203, 209, 210. The logical chains 202, 203, 209, 210 do not contain the stored data of the data environment data structure 200, but rather contain a listing of information about all data packages 204, 205, 206, 207, 208, 211 that are logically related to one another. Each logical chain 202, 203, 209, 210 may contain a variety of information about the data chains 204, 205, 206, 207, 208, 211 as described in reference to FIG. 6 below. The overall data structure 200 may also comprise a global logical chain 201 which contains information about all of the logical chains 202, 203, 209, 210 in the database structure 200 and, either through the information contained within the logical chains 202, 203, 209, 210 or directly from data chains 208 themselves, about the entire data structure 200 and the data chains 204, 205, 206, 207, 208, 211.

Still referring to FIG. 2, the organization and structure of the data structure 200 may vary with respect to how the logical chains 202, 203, 209, 210 and data chains 204, 205, 206, 207, 208, 211 are related to one another or nested with one another. For example, multiple data chains 205, 207 may be tracked by a single logical chain 203 because those data chains 205, 207 are logically related to one another in the data structure 200. Similarly, one logical chain 210 may be tracked by another logical chain 209, which then is tracked within the global logical chain 201. It should be appreciated that a data chain 208 may be directly tracked by the global logical chain 201 with no other interceding logical chains. The data structure 200 may be adapted, arranged or nested in any way as is necessary for a particular application, including with combinations of the above-mentioned arrangements. For example, it may be possible to have nested logical chains 209, 210 to be tracked by another logical chain 203, which also tracks other data chains 205, 207 directly, or any other combination or arrangement such that all data chains 204, 205, 206, 207, 208, 211 are represented within the global logical chain 201 either directly or indirectly.

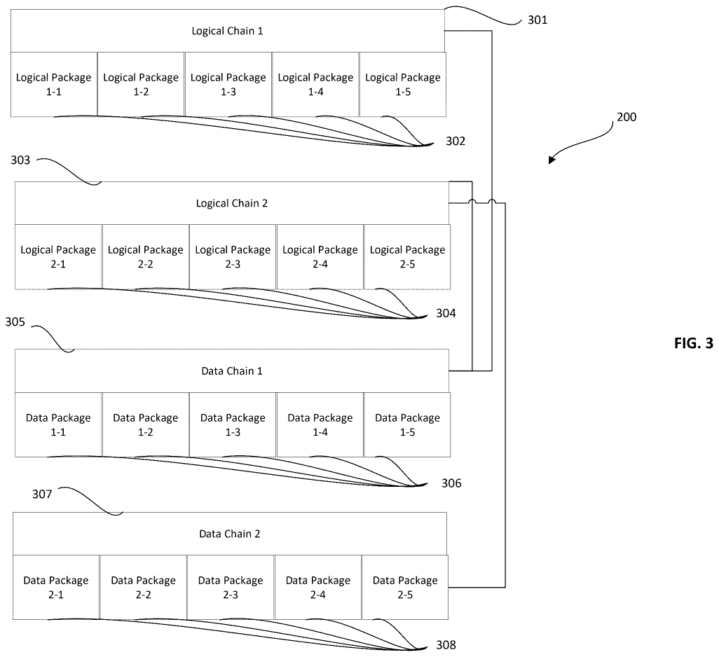

FIG. 3 provides a block diagram of the data structure 200 of the secure chain data environment in a nested configuration. The data structure 200 may comprise a first data chain 305 which comprises a plurality of data packages 306 and a second data chain 307 which may also comprise a plurality of data packages 308. Within each data chain 305, 307, the individual data packages 306, 308 contain the stored data of the secure chain data environment data structure 200. Each data chain 305, 307 represents one division or partition of the data contained within the data structure 200. Within each data chain 305, 307, each data package 306, 308 represents a series of versions of the data contained within the data chain 305, 307. Each data package 306, 308 contains information that links a subsequent data package 306, 308 back to the previous version of the data package 306, 308. This linking of subsequent data packages 306, 308 to previous data package 306, 308 versions allows each data chain 305, 307 to represent one partition or chunk of data in the data structure 200 and how it has changed over time.

Similarly, each logical chain 301, 303 is made up of a series of logical packages 302, 304. Each logical package 302, 304 contains information about one or more data chains 305, 307 and the data packages 306, 308 which make up the associated data chains 305, 307. Logical packages 304, and the logical chain 303 which is made up of the logical packages 304, may correspond to multiple data chains 305, 307 which are logically related to one other in the data structure 200. Similarly, as shown in FIG. 3, a single data chain 305 may be tracked by multiple logical chains 301, 303. It should be appreciated that a logical chain 301, 303 may track or represent any number of data chains 305, 307, and a logical chain 301, 303 may also track or represent other logical chains 301, 303 or a combination of logical chains 301, 303 and data chains 301, 303.

Still referring to FIG. 3, each logical chain 301, 303 may comprise a number of logical packages 302, 304. As with data chains 305, 307, each logical package 302, 304 contains information that links the logical package 302, 304 with a preceding version of the logical package 302, 304 such that the logical chain 301, 303 is a linked list of logical packages 302, 304 and tracks the changes made to the data chains 305, 307 which are tracked or represented by the logical chain 301, 303. The logical chains 301, 303 may then track the changes of any associated data chains 305, 307 by the linked list of logical packages 302, 304 contained therein.

Referring to FIGS. 2 and 3, the overall data structure 200 of the secure chain data environment may contain any variety or arrangements of logical chains 201, 202, 203, 209, 210, 301, 303 and data chains 204, 205, 206, 207, 208, 211, 305, 307. For example, in certain embodiments, the data structure 200 may comprise a global logical chain 201 which tracks and contains information on the entirety of all lower level logical chains 202, 203, 209, 210, 301, 303 and all data chains 204, 205, 206, 207, 208, 211, 305, 307 contained within the secure chain data environment. The global logical chain 201 may not reference certain individual data chains 204, 205, 206, 207, 211, 305, 307 directly, but rather may reference other logical chains 202, 203, 209, 210, 301, 303 which then themselves may reference data chains 204, 205, 206, 207, 211, 305, 307. However, certain individual data chains 208 may be represented directly by the global logical chain 201. It should be appreciated that any implementation of the secure chain database will contain a global logical chain 201.

Beneath the global logical chain 201 may be one or more logical chains 202, 203, 209, 210, 301, 303. These logical chains 202, 203, 209, 210, 301, 303 may be generated to track data chains 204, 205, 206, 207, 211, 305, 307 which are logically related to one another in the overall data structure 200 of the secure chain data environment. For example, referring to FIG. 2, data chain 205 and data chain 207 may represent partitions or chunks of data which are related to one another within the overall data structure 200. A logical chain 203 may then track or represent data chain 205 and data chain 207 and the changes that are made to data chain 205 and data chain 207 as data packages are updated, deleted, or added to the overall data pool. Similarly, another logical chain 202 may track or represent data chain 204 and data chain 206 and any changes, updates, additions, or deletions to data chain 204 and data chain 206. In this way, each logical chain 202, 203 tracks a set of data chains 204, 205, 206, 207 which is logically related to one another. It should be appreciated that within the data structure 200 there may be any number of layers of logical chains. For example, there may be additional logical chains which track logical chain 203, logical chain 202, or both, that are nested below the global logical chain 201.

In certain embodiments, as shown in FIG. 3, the data chains 305, 307 may be related to or contained within more than one logical grouping or partition of data within the database structure 200. For example, a data chain 305 may be tracked or represented by a first logical chain 301 and a second logical chain 303, each of which represents a different logical grouping within the data structure 200. Similarly, a single logical chain 303 may represent a first data chain 305 and a second data chain 307. These relationships between logical chains 301, 303 and data chains 305, 307 may be determined by the partitioning of data within the data structure 200 into the data chains 305, 307. Any number of partitioning methods may be used including, but not limited to partitioning based on hardware, data that is frequently used together, data that is frequently updated together, or other methods of partitioning data such as in alphabetical order, numerical order, or any other method for partitioning data into smaller packages or chunks for use in a data structure 200 as is suited to any particular application or payload software that may use the secure chain data environment.

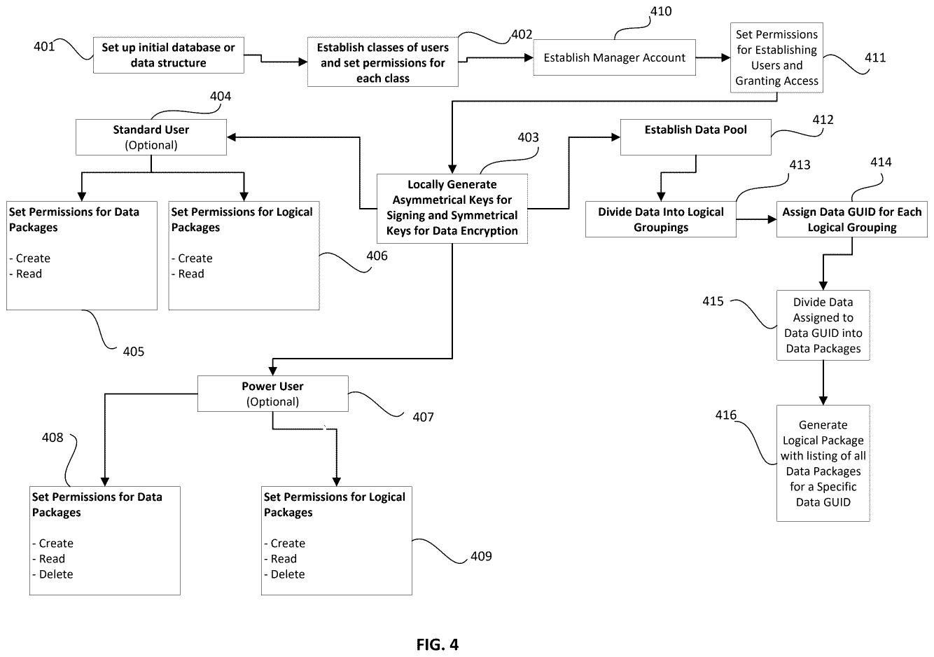

FIG. 4 provides a flowchart of a method for establishing a secure chain data environment. The method may begin by setting up the initial database or data structure 401 in preparation for the introduction of data. Next, one or more user classes may be established and permission for each class of users may be input into the secure chain data environment 402. A manager account may then be established at 410. It should be appreciated that at this stage, a manager account, as described below, must be established to allow for a user to have system access or authority to define user profiles and allow other users into the secure data chain environment as necessary. The system may then read in and set permissions for establishing user accounts and granting access to the secure chain data environment as defined by the manager account at 411. The system may then locally read in or generate both asymmetrical and symmetrical encryption keys at 403. The asymmetrical encryption keys may be used as described in FIG. 1 to allow users to sign data packages or logical packages within the secure chain data environment to establish provenance of data. Symmetrical encryption keys, which should never be placed on or otherwise be available to a server, may then be used to encrypt the data packages and logical packages. It should be appreciated that the secure chain data environment may use any type of symmetrical or asymmetrical encryption keys which may be generated by the software itself, or which may be provided by outside software, tools, or other mechanisms for generating asymmetrical encryption keys. The secure chain data environment is encryption agnostic and may use any type of encryption methods as desired or required for a particular application.

Still referring to FIG. 4, a standard user profile may be established or generated for a local user at 404 along with permission for data packages at 405 and permission for logical packages at 406. As shown, the permissions for both data packages 405 and permissions for logical packages 406 may be to create and read data packages at 405 and logical packages at 406. A power user profile may also be established at 407 with permission for data packages set at 408 and permission for logical packages set at 409.

As shown, data package permissions 408 and logical package permission 409 may include creating and reading of data as with the standard user 404, but also include the additional functionality of deleting data packages and logical packages. It should be appreciated that, depending upon the desired implementation of the secure chain database, any number of user classes with unique user permissions may be accommodated by the secure chain database.

Still referring to FIG. 4, the data pool may be established at 412. The data pool is the sum total of all data that is to be contained within the secure chain data environment. The data pool may then be divided into logical groupings at 413. For example, data within the data pool may be divided such that data which is frequently used together, data which is frequently updated together, or data which may be logically grouped together for other reasons will be located within the same logical grouping. It should be appreciated that certain data may fall within more than one logical grouping, and this data may be labeled or otherwise associated with more than one logical grouping within the secure chain database. Once the logical groupings of the data have been established, the system may assign a data GUID for each logical grouping at 414.

After logical groupings and data GUIDs for the data pool have been established, the data which falls within each logical grouping will be divided into smaller partitions or chunks as data packages at 415. It should be appreciated that the size of each data package may be chosen to reflect hardware parameters or a desired performance parameter of the secure chain database. For example, smaller data packages may work better in environments where transmission of data is less reliable and where a larger listing of data packages may be tolerated. In other implementations, larger data packages may be preferable and reflect a certain type of data which is more effectively divided into larger data packages. In certain embodiments, each data package will contain information related to the one or more data GUIDs that are applied to that data package. In this way, the data GUID functions as a group identifier for the data pool data. The secure chain database may then generate a logical package corresponding to each data GUID and which contains a listing of all data packages associated with that data GUID at 416.

FIG. 5 provides a schematic depiction of an exemplary embodiment of the data package 501 data structure. The data package 501 may include a header 502, which is encrypted with a symmetrical data grouping key. This header 502 may contain information such as a listing of the one or more data GUIDs 503 associated with this data package 501, and a field for the type of package 504. The header 502 may also include the checksum of the last overall, or system wide, logical package 505. This listing of the last overall logical package 505 in the data environment provides a field for organization of all updated data packages 501 in chronological order in the system regardless of its associated data GUID 503 The checksum of the last data package within this data chain 505 associates this data package 501 with the previous version of this data package 501 such that the secure chain database may then identify the last data package 501 and rebuild the chain of versions of this data package 501. It should be appreciated that if the data package 501 is the first data package 501 in a data chain, the last data package checksum 506 may be set to a null value or another value to indicate the data package 501 is the first data package 501 in the data chain and there is no preceding data package 501. The header 502 may also include a field for data size 506 to allow the system to know how large the encrypted data structure 510 is, and a random buffer string 508 to allow the header 502 to be of a predetermined, standardized size. Similarly, the data package 501 may also include optional buffer data 509 with the encrypted data structure 510 to allow all data packages 501 to have identical data sizes and to provide extra protection against hacking or unauthorized use of the data contained within the data packages 501.

FIG. 6 provides a schematic depiction of an exemplary embodiment of the logical package 601 data structure. The logical package 601 has a header 602 which may be encrypted using the same symmetrical data grouping key as for the data package 501 referenced above. Within the header 602, there is a listing of the one or more data GUIDs 603 that are associated with this logical package 601 and a field for the type of package 604. The header 602 may also include a field for the last overall logical package checksum 605 and for the checksum of the previous logical package in this logical chain 606. The field for the last overall logical package checksum 605 allows the secure chain data environment to associate this logical package 602 and its order of generation across the entire data environment in a linked list. Similarly, the checksum of the previous logical package in this logical chain 606 allows the secure chain data environment to determine the order of this logical package 601 within its own logical chain. It should be appreciated that if the logical package 601 is the first logical package 601 in a logical chain, the last logical package checksum 606 may be set to a null value or another value to indicate the logical package 601 is the first logical package 601 in the logical chain and there is no preceding logical package 601. This use of the last overall logical package checksum 605 and the checksum of the previous logical package in this chain 606 provides the secure chain data environment with an ordered linked list allowing the system to re-create the logical chain and identify all data by its public checksum and to assure data coherence as described below.

The header 602 of the logical package 601 may also include a field for data size 607 describing the size of the encrypted data 610, and a random buffer string 608 to ensure that the header 602 is of a uniform and standard size matching all other headers in all other logical packages. The logical package 601 also includes the encrypted data 610. In this case, the encrypted data 610 is not the base data of the database, but rather is a listing of all checksums and data GUIDs of all data packages and logical packages associated with the data GUID of this logical package 601. Optional buffer data 609 may also be included in the logical package 601 to ensure that the entire logical package 601 is of a uniform data size that matches all other logical packages 601 and data packages in the secure chain data environment.

Referring to FIGS. 5 and 6, there are a number of variations to the data packages 501 and logical packages 601 that may be used to adapt the secure chain database to a particular implementation or use case. It should be appreciated that the headers 502, 602 of the data package 501 and logical package 601 must use the same symmetric encryption key when associated with the same data GUID. This use of a common key for the headers 502, 602 ensures that a symmetric encryption key cannot be used to determine the type of package in the case of an unauthorized user or access of any data package 501 or logical package 602. This, along with the standardization of header 502, 602 data length and package 501, 601 data length ensures that all packages 501, 601 appear only as generic packages to an outside observer. Furthermore, a standard header 502, 602 length may allow for an increase in processing efficiency. A local machine may only decrypt the first set of data corresponding to the header 502, 602 size that has been established within the secure chain data environment without having to decrypt the entire package 501, 601. However, in certain embodiments, the encrypted data 510, 610 may use a different symmetric encryption key than the header 502, 602. For example, the secure chain database may use a single symmetric encryption key for all encrypted data 510, 610, a symmetric encryption key for data package 501 encrypted data 510 and a separate symmetric encryption key for logical package 601 encrypted data 610, or even unique symmetric encryption keys for every data package 501 and logical package 601 corresponding to a particular data GUID in the secure chain data environment. These unique symmetric encryption keys may be either stored on the local machine of a user, or they may be contained within the encrypted data 510, 610 of a particular data package 501 or logical package 601 held on the server. However, in no circumstance should any symmetric encryption key be available to the server to prevent the server from having access to any encrypted data 510, 610 and all data packages and logical packages will only be seen as generic packages by the server. It should be appreciated that the data structure of the secure chain database ensures that the server is always ignorant of the data contained within the data packages 501 and logical packages 601. All packages 501, 601 are identified by their unique checksum calculated from the encrypted data. This listing of checksums serves as the only identifier of each package 501, 601 on the server such that the server never has access to the header 502, 602 or any data 510, 610 contained within a package 501, 601. However, because the information contained within the header 502, 602 of each package 501, 601 that identifies the previous package checksum 506, 606, the local machine may identify all of the packages 501, 601 in any data chain or logical chain and use the listing of checksums to identify all data packages 501 and logical packages 601 on the server and download them as necessary for use of the secure chain database. Similarly, because of the information contained within the header 502, 602 of each package 501, 601 for the last overall logical package checksum 505, 605 allows the local machine to identify the ordering of all packages within the secure chain data environment.

Still referring to FIGS. 5 and 6, the packages 501, 601 may also include a number of optional variations to adapt the secure chain database to a particular use case or implementation. For example, in certain embodiments, some information such as the data GUID field 503, 603 may be placed outside the encrypted header 502, 602 to allow the server to provide some additional processing functions for the secure chain database. It should be appreciated that the server may, in certain embodiments, be provided with more or less information about the data within the secure chain data environment to allow the server to provide computational resources. The selection of server permission may be made to customize the secure chain data environment to any particular application and may be adjusted to allow for more or less security within the secure chain data environment. In still further embodiments, the data packages 501, logical packages 601, or both may include a time field that records the time and date of the creation of the package 501, 601 to further help in ordering and organizing packages 501, 601 on the secure chain database. The packages 501, 601 may also include fields for recording the user which created each package 501, 601 or other identifying information. It should be appreciated that the secure chain data environment may also include other types of packages to perform specific functions for a particular use case or implementation of the secure chain database. For example, the end-to-end encrypted data protection system may include a specific set of packages that define user permission or other parameters of the end-to-end encrypted data protection system.

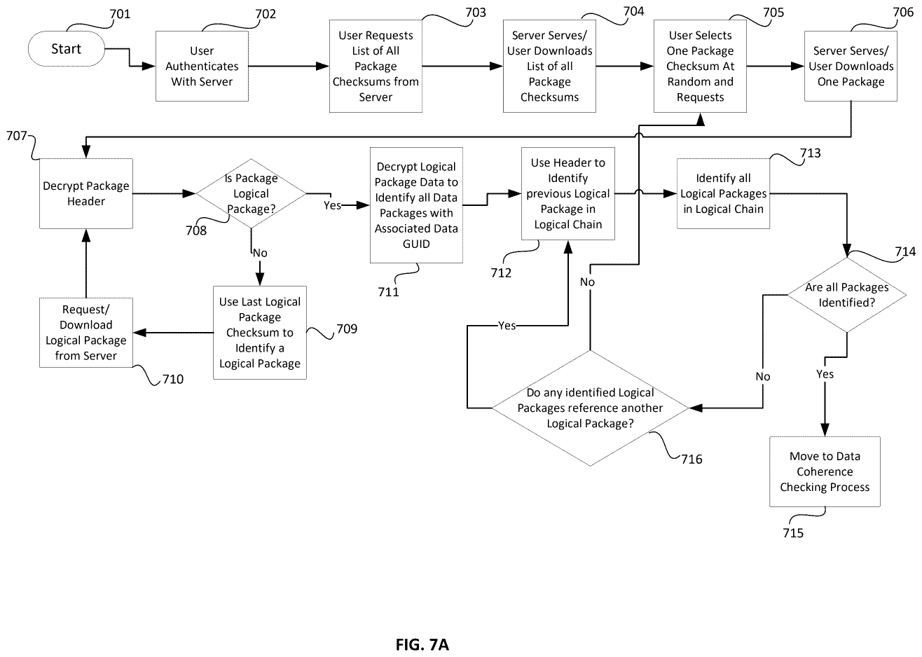

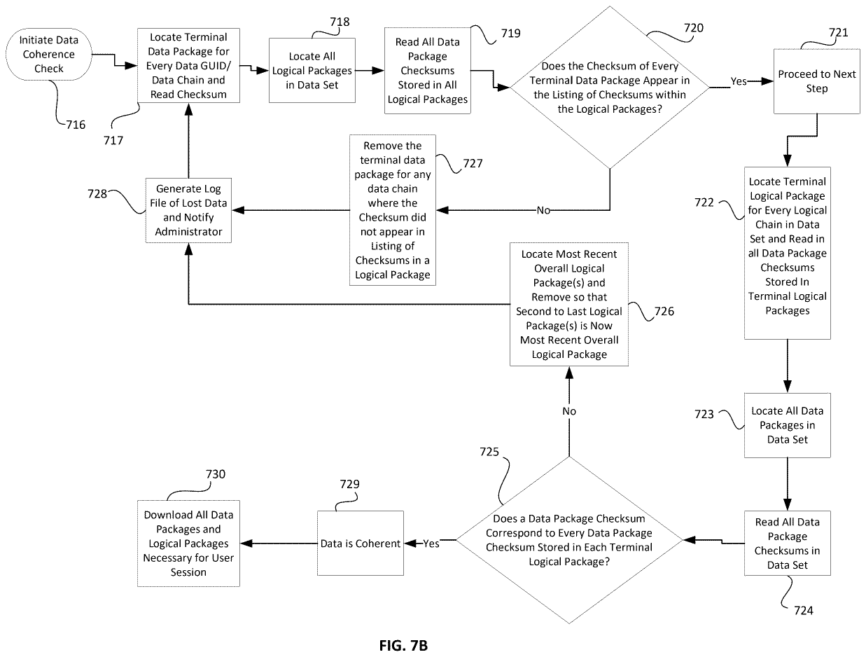

FIG. 7A provides a flowchart of an exemplary embodiment of a method for identifying all data packages and logical packages using a listing of checksums in a secure chain data environment. The method may be initialized at 701 when a user logs into the secure chain data environment from a local machine and authenticates with the server at 702. Once authenticated, the user may request a list of all package checksums from the server at 703. The server may then serve up, and the user may download, the listing of all package checksums at 704. The local machine of the user may then select one package checksum at random and request that the server serve up that package at 705. The server may then serve up, and the local machine may download, the randomly selected generic package at 706. Once downloaded, the local machine may decrypt the package header using the data grouping symmetric encryption key at 707. The local machine, after decrypting the header of the downloaded generic package, may query and determine whether the downloaded generic package is a logical package or a data package at 708. If the generic package is not a logical package, the local machine may use the last overall logical package checksum field of the header of the data package to identify a logical package at 709. The local machine may then request and download the logical package with the last logical package checksum from the server at 710. The local machine may then decrypt the package header again at 707 of the newly downloaded generic package and query if the package is a logical package at 708.

If the generic package is a logical package at 708, either as the original randomly selected package or as the subsequently downloaded package at 710, the local machine may then decrypt the logical package data to identify all packages which are listed within the encrypted data of the logical package by their checksum and with their associated data GUIDs at 711. Through this process, the local machine can begin assigning checksums from the list of all package checksums received at 703 to data packages and logical packages to begin identifying all generic packages in the list of checksums. The local machine may also use the header information from the logical package identified at 708 to identify the previous logical package in the logical chain at 712. The local machine may then work back through the list of logical packages using the header information for the previous logical package checksum to identify all logical packages in the logical chain for a given data GUID at 713. As the local machine works its way through the logical chain, it may continue to query whether any previous logical packages in the identified logical chain list any other packages within their respective encrypted data fields to continue identifying packages in the secure chain data environment by their checksums. Once the local machine has worked back to the originating or first logical package in the selected logical chain, it may query whether all checksums on the list of checksums received at 703 have been identified at 714. If all packages have not been identified, the system may query whether or not any already identified logical packages reference other logical packages at 716. If there are other logical packages referenced not within the identified logical chain, the local machine may use the header to identify the other logical packages in a new logical chain at 712 and continue the logic loop to identify more generic packages. If, however, no logical packages reference another logical package at 716 and there are still unidentified packages in the secure chain data environment, the local machine may then select another unknown package at random at 705 and repeat the logic loop until the query at 714 indicates that all packages have been identified. Once all packages have been identified to satisfy the query at 714, the local machine may move to the data coherence check at 715.

FIG. 7B provides a flowchart of an exemplary embodiment of a method for checking and rectifying data coherence in the secure chain data environment. The data coherence check may be initiated at 716 after all checksums in the secure chain data environment have been identified. The local machine may then query the system to locate the terminal data package for every data GUID and data chain within the data pool and read in the associated checksums. The local machine may then locate all the logical packages in the entire data pool at 718 and read in all the data package checksums contained within the logical packages at 719. The local machine may then make a comparison to determine if the checksum of every terminal data package is represented within the listing of all checksums contained within the encrypted data of all logical packages at 720. If one of the terminal data package checksums is not present within the list of all checksums recorded within all logical packages, this indicates that there is extraneous data that has not been recorded by any logical package within the secure chain data environment. The local machine may then remove the data package for any data chain where the checksum for the terminal data package did not appear in the listing of all data checksums recorded by all logical packages in the secure chain data environment at 727. The system may remove the extraneous data packages either by flagging those data packages in the system, deleting them, or otherwise preventing their use. The system may then generate a log file at 728 to create a log of any lost data and notify an administrator or manager who may then address any issues with the secure chain data environment. The system may then repeat this process by returning to step 717 and continuing to look for unrecorded data packages until the checksum of every terminal data package appears within the listing of checksums contained within all logical packages at 720.

If all the checksums of every terminal data package appear within the listing of checksums contained within all logical packages at 720, the system may then move to step 721 and proceed to the next step in checking data coherence. The local machine will now locate the terminal logical package for every logical chain in the secure chain data environment and read in all data package checksums contained within the encrypted data of the terminal logical packages for every logical chain at 722. The local machine may then locate all data packages in the entire data pool at 723 and read in the checksums for all data packages in the data pool at 724. It should be appreciated that in certain embodiments, the listing of all data package checksums may already be obtained through the processes explained in reference to FIG. 7A above. The local machine may now make a comparison to determine if a data package checksum corresponds to every data package checksum stored in the encrypted data of each terminal logical package at 725. If there are data package checksums which appear in the encrypted data of a terminal logical package but do not appear in the listing of all data package checksums, this indicates that there is one or more data packages which have been lost. In this case, the system may then locate the most recent overall locking package in the system and remove it from the data environment such that the second to last logical package is now the most recent overall logical package at 726. It should be appreciated that the logical package which is removed is the last overall logical package in the entire secure chain data environment and corresponds to the final logical package and not the final logical package of a single logical chain. This final overall logical package may be determined by using the last overall logical package checksum field 505, 605 within the headers 502, 602 of the data packages 501 and logical packages 601. Once this final overall logical package has been removed from the secure chain data environment, the system may generate a log file of the lost data and notify an administrator at 728. The local machine may then restart the process from step 717, as it is now possible that there may be extraneous data on the system. Therefore, to ensure data coherence, the system must first pass the query at 720 and then the query at 725 in sequence prior to determining the data is coherent at 729. Once the system has determined the data is coherent, it may download all data packages and logical packages necessary for the user session at 730. The local machine will now have a full listing of all coherent packages in the secure chain database and may use all data in the database as permitted by the user type or as necessary for the user session.

Still referring to FIG. 7B, it should be appreciated that the system may carry out the data coherence check without necessarily downloading all of the data on the secure chain data environment. Rather, the header information and the processes of FIG. 7A allow for the data coherence check to be carried out without a full download of all data within the data pool. Furthermore, in certain embodiments, the local machine or the overall system may trigger a global update of the secure chain data pool after the data coherence check, or after any data coherence rectification process as described within step 726 or step 727, or it may continue use of the secure chain data environment without a global update.

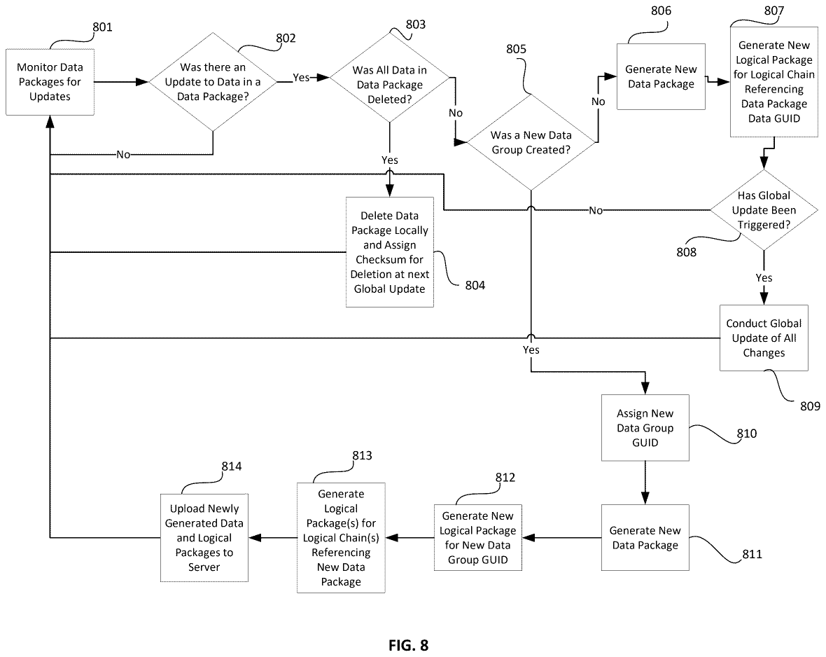

FIG. 8 provides a flowchart of an exemplary embodiment of a method for updating data chains and logical chains in a secure chain database. While the secure chain database is in use on a local machine, the system may monitor the data packages for any updates or changes to the data packages at 801. If no changes to the data in any data packages are found at 802, the local machine may continue to monitor for updates at 801. If, however, the local machine notes an update or change to the data in a data package at 802, the local machine may query whether all the data in the data package was deleted at 803. If all the data in a data package was deleted, then the local machine may delete the data package locally and assign the checksum for deletion from the global list of checksums during the next global update at 804. If all the data in a data package was not deleted, the local machine may then query whether a new data group was created at 805.

If a new data group has been created at 805, the local machine may assign a new data group GUID at 810 and generate a new data package at 811. The local machine may then generate a new logical package for the new data group GUID at 812 and generate new logical packages at 813 for any existing logical chains that reference the new data package generated at 811. The newly generated data package and logical packages may then be uploaded to the server at 814 and the local machine may return to monitoring data packages for updates at 801.

If a new data group has not been created at 805, then the local machine may generate a new data package at 806 and generate a new logical package for the logical chain that references the data GUID of the updated data package at 807. After the new data and logical packages have been generated, the local machine may query whether a global update has been triggered at 808. If no global update has been triggered, the local machine may return to monitoring data packages for changes at 801. If a global update has been triggered at 808, then the local machine may conduct a global update of all changes in the secure chain database at 809. It should be appreciated that a global update wherein all newly generated data packages and logical packages are uploaded to the server may be triggered by any number of means. For example, in certain embodiments, a global update may be triggered manually by a user. In still further embodiments, a global update may be triggered automatically by the secure chain database system. The trigger for a global update may be any number of factors including, but not limited to a time trigger, or triggers related to a number of data packages updated, number of new logical packages created, or any number of other system triggers.

It should be appreciated that the secure chain data environment may be adapted to a number of different updating and monitoring strategies. For example, the secure chain data environment may use a strict management strategy wherein every change that results in the creation of a new data package triggers the creation of a new logical package in every logical chain that references the data chain with a new data package. However, it is also possible to have a more limited monitoring system wherein the creation of a new data package results in only an update to any logical chains that directly reference the newly generated data package. Other logical chains which reference the data chain with the newly generated data package may simply refer to the logical chains that directly reference the newly generated data package. These higher level chains without a direct reference to the newly generated data package may then be updated at a later date when triggered by the system, a user, or as part of a global system update.

In summary, while the present invention has been described with respect to specific embodiments, many modifications, variations, alterations, substitutions, and equivalents will be apparent to those skilled in the art. The present invention is not to be limited in scope by any of the specific embodiments described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

It should be appreciated that any element, part, section, subsection, or component described with reference to any specific embodiment above may be incorporated with, integrated into, or otherwise adapted for use with any other embodiment described herein unless specifically noted otherwise or if it should render the embodiment device non-functional. Likewise, any step described with reference to a particular method or process may be integrated, incorporated, or otherwise combined with other methods or processes described herein unless specifically stated otherwise or if it should render the embodiment method nonfunctional. Furthermore, multiple embodiment devices or embodiment methods may be combined, incorporated, or otherwise integrated into one another to construct or develop further embodiments of the invention described herein.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particular interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

I claim:

1. An encrypted data environment system comprising:
at least one local machine in communication with at least one server;
wherein said at least one local machine partitions a set of data into data packages comprising a data package header and associates said data packagers based on logical relationships, assigns a data group GUID to each said logical relationship of said data packages, generates a logical package comprising a logical package header for each said data group GUID, assigns a logical GUID to each said logical package; encrypts each said data package and each said logical package into a generic package to form a generic package group, and uploads said generic package group to said server;
said at least one server receives and stores said generic package group and wherein said at least one server serves up packages from said generic package group on request by said at least one local machine;
said at least one local machine may request a listing of checksums of each said generic package of said generic package group and request one random generic package from said generic package group and decrypt a header of said one random generic package to identify said generic packages and generate a listing of all said data packages and said logical packages corresponding to said listing of checksums;
said local machine manipulates one or more of said data packages to generate an updated data package, said local machine links said updated data package to said data package via a field in a header of said updated data package, and said local machine generates an updated logical package for said updated data package and links said updated logical package to said logical package via a field in a header of said updated logical package; and
wherein said updated data package and said data package form a data chain and said logical package and said updated logical package form a logical chain.

2. The encrypted data environment system of claim 1, wherein said identification of said generic packages comprises:
identifying said decrypted header of said one random generic package as a data header or logical header;
reading a last logical package checksum field in said decrypted header of said one random generic package;
identifying a specific generic package from said server corresponding to said last logical package checksum field in said decrypted header of said one random generic package and requesting said specific generic package from said server corresponding to said last logical package checksum field in said decrypted header of said one random generic package; and
decrypting said specific generic package from said server and identifying all said generic packages on said listing of checksums by data from said specific generic package.

3. The encrypted data environment system of claim 1, wherein said data package header and said logical package header comprise a header buffer string such that each of said data package headers and said logical package headers comprise a standard header data length.

4. The encrypted data environment system of claim 1, wherein said data packages said logical packages comprise a package buffer string such that each of said data packages and said logical packages comprise a standard package data length.

5. A method of data environment management comprising:
partitioning a set of data into data packages, each said data package comprising a data package header;
associating said data packages based on logical relationships;
assigning a data group GUID to each said logical relationship of said data packages;
generating a logical package comprising a logical package header for each said data group GUID;
assign a logical GUID to each said logical package;
encrypting each said data package and each said logical package into a generic package to form a generic package group;
uploading said generic package group to a server;
storing said generic package group on said server;
serving up packages from said generic package group on request;
requesting a listing of checksums of each said generic package of said generic package group and requesting one random generic package from said generic package group;
decrypting a header of said one random generic package to identify said generic packages and generate a listing of all said data packages and said logical packages corresponding to said listing of checksums;
manipulating one or more of said data packages to generate an updated data package;
linking said updated data package to said data package via a field in a header of said updated data package;
generating an updated logical package for said updated data package and linking said updated logical package to said logical package via a field in a header of said updated logical package; and
generating a data chain from said data package and said updated data package and generating a logical chain from said logical package and said updated logical package.

6. The method of data environment management of claim 5, wherein said identification of said generic packages comprises:
identifying said decrypted header of said one random generic package as a data header or a logical header;
reading a last logical package checksum field in said decrypted header of said one random generic package;
identifying a specific generic package by checksum from said listing of checksums corresponding to said last logical package checksum field in said decrypted header of said one random generic package and requesting said specific generic package from said server; and
decrypting said specific generic package from said server and identifying all said generic packages on said listing of checksums by data from said specific generic package.

7. The method of data environment management of claim 5, further comprising generating a data package header buffer string for each said data package header and a logical package header buffer string for each said logical package header such that each of said data package headers and said logical package headers comprise a standard header data length.

8. The method of data environment management of claim 5, further comprising generating a data package buffer string for each said data package and generating a logical package buffer string for each said logical package such that each of said data packages and each of said logical packages comprises a standard package data length.

9. At least one computer-readable storage medium having instructions recorded thereon which, when executed by a computer, cause the computer to perform a method for data environment management, the method comprising:
partitioning a set of data into data packages, each said data package comprising a data package header;
associating said data packages based on logical relationships;
assigning a data group GUID to each said logical relationship of said data packages;
generating a logical package comprising a logical package header for each said data group GUID;
assign a logical GUID to each said logical package;
encrypting each said data package and each said logical package into a generic package to form a generic package group;
uploading said generic package group to a server;
storing said generic package group on said server;
serving up packages from said generic package group on request;
requesting a listing of checksums of each said generic package of said generic package group and requesting one random generic package from said generic package group;
decrypting a header of said one random generic package to identify said generic packages and generate a listing of all said data packages and said logical packages corresponding to said listing of checksums;
manipulating one or more of said data packages to generate an updated data package;
linking said updated data package to said data package via a field in a header of said updated data package;
generating an updated logical package for said updated data package and linking said updated logical package to said logical package via a field in a header of said updated logical package; and
generating a data chain from said data package and said updated data package and generating a logical chain from said logical package and said updated logical package.

10. The computer-readable storage medium of claim 9, wherein said identification of said generic packages comprises:
identifying said decrypted header of said one random generic package as a data header or a logical header;
reading a last logical package checksum field in said decrypted header of said one random generic package;
identifying a specific generic package by checksum from said listing of checksums corresponding to said last logical package checksum field in said decrypted header of said one random generic package and requesting said specific generic package from said server; and
decrypting said specific generic package from said server and identifying all said generic packages on said listing of checksums by data from said specific generic package.

11. The computer-readable storage medium of claim 9, further comprising generating a data package header buffer string for each said data package header and a logical package header buffer string for each said logical package header such that each of said data package headers and said logical package headers comprise a standard header data length.

12. The computer-readable storage medium of claim 9, further comprising generating a data package buffer string for each said data package and generating a logical package buffer string for each said logical package such that each of said data packages and each of said logical packages comprises a standard package data length.
